(19) United States
(12) Patent Application Publication
(10) Pub. No.: US 2011/0140407 A1
(43) Pub. Date: Jun. 16, 2011

(54) REAR LOADING MEDIA STORAGE DEVICE

(76) Inventor: SCOTT Vincent KLEIN, St. Louis, MO (US)

(21) Appl. No.: 13/033,261

(22) Filed: Feb. 23, 2011

Related U.S. Application Data
(62) Division of application No. 12/196,370, filed on Aug. 22, 2008.
(60) Provisional application No. 60/957,854, filed on Aug. 24, 2007.

(51) Int. Cl. B42D 1/00; B65D 85/57; B42D 115/00

(52) U.S. Cl. 281/31; 206/308.1; 206/232

(57) ABSTRACT

A sheet secures at least one media or marketing material, such as a CD, onto the sheet for placement as a display or for sale. The sheet warns shoppers that a CD has been removed. The sheet has at least one flap extending through the center of the CD leaving the upper half visible. The flaps are formed with cut lines as a radial line, a band, a business card, or an artistic flap. Generally opposite the flap, one tab grips the CD. A baseline, also a cut line, extends about 1.5 times the thickness of the CD to each end of the cut line. A CD is inserted into the rear of the sheet below the tab and the flaps to secure it upon the panel. The cut line, flaps, and tab can be used singly or in multiples. The CD remains secured until a consumer breaks the flaps after purchase.

### CROSS REFERENCE TO RELATED APPLICATION

This divisional application claims priority to the pending non-provisional application having Ser. No. 12/196,370 with a filing date of Aug. 22, 2008 which claims priority to the expired provisional application having Ser. No. 60/957,854 with a filing date of Aug. 24, 2007, and all three applications are commonly owned by the same inventor.

This divisional application of a preceding utility application is filed under 37 CFR 1.53(b). Pursuant to MPEP 201.06, the preceding utility application Ser. No. 12/196,370 is in group art unit 3728 and did not have a classification stated in the Office Action dated May 26, 2010 listing the restriction requirement.

### BACKGROUND OF THE INVENTION

The rear loading disc storage device generally relates to packaging for disc shaped media and more specifically to a package that loads a disc from the is rear of the package.

People have artistic aspirations in varying degree. A few show noticeable artistic talent and go on to success. The success can be in arts with a manual component such as painting, drawing, needlepoint, embroidery, etching and the like. These arts use tools held in the hand, such as a brush, pen, or needle, to make an image. These arts create an image of a scene, person, or abstract concept upon a medium, generally for exhibition upon a flat surface. The image can be mono-chrome or colorful and have varying degrees of detail. Talented artists can create such images from scratch. For others, such as novices, a little guidance assists a person in completing the creation of an image.

Over the years, the guidance has taken the form of various patterns. The patterns allow a novice artist to size an image, define details within the image, and to apply colors in appropriate locations. Patterns vary from paint by number where numbers upon a lined drawing indicate color locations, to templates for cutting cloth for sewing, to entire patterns including sizing and coloration for threads used in embroidery, and the like. Patterns have been published in paper form and sold through catalogs for many years. However, recently developments in computing and automation of embroidery and sewing machines have encouraged migration of patterns from paper to digital media. The digital media has taken various forms.

From early Winchester hard disks, digital media has used disks of various kinds. The arrival of the personal computer brought with it external floppy disk drives that used magnetic media read by a head in a drive unit. The floppy disks started at eleven inch width, migrated to five and one quarter inch width, and generally remain at three and one half inch width at present. The floppy disk has a maximum storage limit, presently 1.44 MB.

Recent years have seen the evolution of optical memory storage devices, commonly called compact discs. Initially deployed for audio playback, optical discs have migrated into personal computers and digital media. An optical disc has pits printed onto a plastic medium that are read by a laser on a head in a drive or machine component. Initially, optical discs had read only capability which allowed for distribution of music and software but not storage to the optical discs. The optical discs then evolved read and write once capability which allowed users to store programs and self-created data to replace floppy disks. In time, optical discs gained the read and write many capability and the cost dropped noticeably. An optical disc also has a storage limit of approximately 720 MB again depending on formatting type. Optical discs, commonly called CDs, can store many patterns and be readily mailed.

Returning to patterns for novice artists, published printed patterns remained relatively secure from theft as a an entire magazine or book would have to be lifted. Vendors placed anti-theft tags readily upon the book covers. In recent years, publishers have now placed CDs within books and magazines and sold CDs standing alone. CDs have a generally small size and thickness. Thieves have been known to remove CDs from books and magazines only to leave the looted books and magazines behind for the frustrated merchant to discover.

### DESCRIPTION OF THE PRIOR ART

Over the years, various forms of mailers, envelopes, and packages of many kinds have sought to protect CDs at a minimum from handling but also to secure the CDs to the package until removed by the ultimate, or paying, consumer of the CD. Mailers have encased CDs and protected them from handling in the mails and an empty mailer indicates loss of the CD readily to the consumer. Packages can hold CDs but an overlying flap or lid may conceal the absence of a CD from the consumer and the merchant. The prior art packages receive CDs from various directions and generally require additional labor or mechanization for the insertion of a CD within the package. Prior art mailers and packages have had varying degrees of success in securing CDs for the ultimate consumer at minimal labor or machining cost.

For example, the U.S. patent to Drier, U.S. Pat. No. 6,016,907 shows an insert for a periodical that has four continuous panels. The panels fold from left to right and the first panel 22 has a punched opening, as at 32, for holding a media disc, across its entire diameter. The second panel has a semi-circular cover that detaches from line 36. Upon folding the first onto the second panel, a gap 64 remains for insertion of a media disc. Generally, the first panel adheres to the second panel with adhesive. The present invention though has a semi circular cut out cooperating with radial bands that secure a media disc without an adhesive and consecutive folding of panels.

The patent to Lux, U.S. Pat. No. 6,446,417 shows a folding sleeve for holding an article, or a media disc, where the folding sleeve has a round window 16 that displays an article adhered to the bottom wall 31. A retaining flap 15 follows the perimeter of the window and has three finger holes. The retaining flap further has a perimeter scoring that allows a person to detach the retaining flap with a thumb. This patent is similar to the present invention however, it uses adhesive and a perimeter flap where the present invention secures an article with friction and radial bands. Additionally, this patent is for a method of packaging and not for the particular structure of a packaging blank.

The patent application to Lux, 2003/0006153 shows again a folding sleeve for holding a media disc as a packaging blank. The application discloses a three part panel that folds to reveal a round display window. As above, the display window has a perimeter flap that detaches from scoring using finger holes. The present invention with the radial bands and semicircular opening differs from this application.

The patent to Pace et al., U.S. Pat. No. 5,713,605 has a folder for storing media discs in a mailer or publication with two panels that fold upon a centerline. One panel has a round hole for viewing of a media disc and the other panel has a tear off flap to access the media disc. The media disc has a releasable adhesive for securing upon the second panel. The present invention though has a single panel perforated with radial bands for accessing a media disc therein. The patent to Kato, U.S. Pat. No. 6,250,462 shows a short book like casing for media discs. This casing has covers that accept media discs into an accommodating space 18 within an intermediate member 19 that is closed by a lining member 20. The intermediate member has a round aperture for the accommodating space while the lining member has a detachable flap 24.

The patent to Wynalda and Hulbert, U.S. Pat. No. 6,845,865 is similar to Drier with four consecutive folding panels. Two panels have a round opening for placement of a media disc and a third panel has a removable door that releases a media disc from the container. The removable door and a fourth panel secure the media disc within the container but do not permit viewing of the disc. The door also reveals the entire disc whereas the present invention has a portion of a disc revealed behind radial bands of a single panel.

The patent application to Telleen, No. 2005/0116462 shows a three panel holder for the magnetic room keys used in hotels. This application showed a holder that has incentives upon it so a user separates a key from the room number identified upon the holder. One incentive is a media disc inserted halfway into a slot. Though similar to the present invention, this application does not disclose radial bands that secure a media disc within a holder while allowing a person to see the disc.

And the patent to Liddel, U.S. Pat. No. 7,156,288 describes a three sheet envelope for a media disc. The envelope has parallel and spaced apart top and bottom sheets. A center sheet has a rounded aperture upon one end and the sheet inserts between the other two sheets. The three sheets are laminated to each other with adhesive. A media disc then is inserted between the sheets into the aperture and secured with a flap from the bottom sheet. The present invention using a single sheet of material and radial bands that reveal a media disc contained.

The present invention overcomes the difficulties of the prior art. That is, the prior art has utilized various packages with interleaving panels that contain CDs and various means of retaining a CD within a panel. Generally the prior art has loaded CDs from the front of the package which incurred higher labor and assembly costs.

### SUMMARY OF THE INVENTION

Generally, the present invention is a planar sheet that secures at least one CD or other media disc, onto the sheet for placement within printed material upon public display for sale. The invention notifies later shoppers and the merchant that a CD has been lifted from it. The sheet has at least one flap extending from a cut line and partially over a CD leaving the upper half visible. The flaps can be radial upon the left and right edges or the center only, a band across the cut line, or an artistic flap. Opposite the flap, the sheet has one tab that grips the CD across from the visible CD portion. The cut line extends about 1.5 times the thickness of the CD to each end of the cut line. A CD is inserted into the rear of the sheet below the tab and beneath the flaps. The cut line, flaps, and tab can be used singly or in multiples. The CD remains secured until a consumer breaks the flaps upon purchasing the CD and printed material.

There has thus been outlined, rather broadly, the more important features of the invention in order that the detailed description thereof that follows may be better understood and that the present contribution to the art may be better appreciated. The present invention also includes warning indicia for display after a CD has been lifted, a single band across the diameter of a CD, and artistic forms of the bands. The configuration of the cuts, perforations, and scores of the invention allows objects, such as digital media storage devices, to be loaded into the rear, or back, of the invention and the objects cannot be removed from the front of the invention unless and until the security tabs of the invention are removed by the buyer of the device. The object held within the device is thus secure while those tabs remain intact. Additionally, printed indicia, or warnings, upon the front of the device are concealed by stored objects but then displayed when the objects are removed. The warnings enhance the integrity of the stored objects prior to purchase and also alert merchants and buyers to any theft of an object prior to purchase and remind the buyer to replace the object within the device for storage following purchase. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved rear loading disc storage device.

Another object is to provide such a storage device that operates with efficient use of materials during manufacturing thereof.

Another object is to provide such a storage device that has an integral security system for CDs.

Another object is to provide such a storage device that heightens the security of CDs on display to the public.

Another object is to provide such a storage device that warns shoppers and merchants when a CD has been removed from the device prior to purchase.

Another object is to provide such a storage device that provides storage for many years both before and after the sale of the CD to the consumer.

Another object is to provide such a storage device that eliminates security tapes, acetate windows, additional sleeves, and envelopes, and like security features.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 describes a top view of the preferred embodiment of the present invention where for securing media behind an arcuate upper slot and a lower tab;

FIG. 2 shows a top view of an alternate embodiment of the present invention where a CD is secured behind two wedges in the upper half and a lower tab;

FIG. 3 shows a top view of a CD secured behind the alternate embodiment of FIG. 2;

FIG. 4 describes an alternate embodiment where a CD is secured behind two radial straps above a lower tab;

FIG. 5 describes an alternate embodiment where a CD is secured behind one radial strap generally extending with the longitudinal axis of the printed material;

FIG. 6 is a top view of the preferred embodiment where the arcuate upper slot has been lowered closer to the center of the CD;

FIG. 7 is a top view of an alternate embodiment where two arcuate tabs extend radially inward from the perimeter in the upper half with a tab in the lower half to secure a CD;

FIG. 8 is bottom view of the alternate embodiment of FIG. 7 with a CD shown behind the three tabs;

FIG. 9 is a top view of the alternate embodiment of FIG. 7 with a CD shown below the three tabs;

FIG. 10 is a top view of an alternate embodiment of the invention where radial tabs in an artistic fashion secure a CD above a lower tab;

FIG. 11 is a cover shown in flat with two folding panels having four versions of the invention incised thereon;

FIG. 12 is another cover, in flat, shown with two folding panels where one panel has two locations for CD or other media and the other panel has a score for revealing a folder;

FIG. 13 is a mailer, in flat with one location for a CD;

FIG. 14 is a mailer, in flat with two spaced apart locations for CD or other media;

FIG. 15 is another mailer, in flat with one location for a CD where the location has a scoop shaped like a business card;

FIG. 16 is the mailer of FIG. 15 with the location for a CD shown in landscape form;

FIG. 17 shows a different mailer, in flat form with one location for a CD and scoring to hold a separate business card;

FIG. 18 again shows a different mailer, in flat form with four locations for gift cards; and,

FIG. 19 shows a mailer, with a CD location similar to that of FIG. 10.

The same reference numerals refer to the same parts throughout the various figures.

### DESCRIPTION OF THE PREFERRED EMBODIMENT

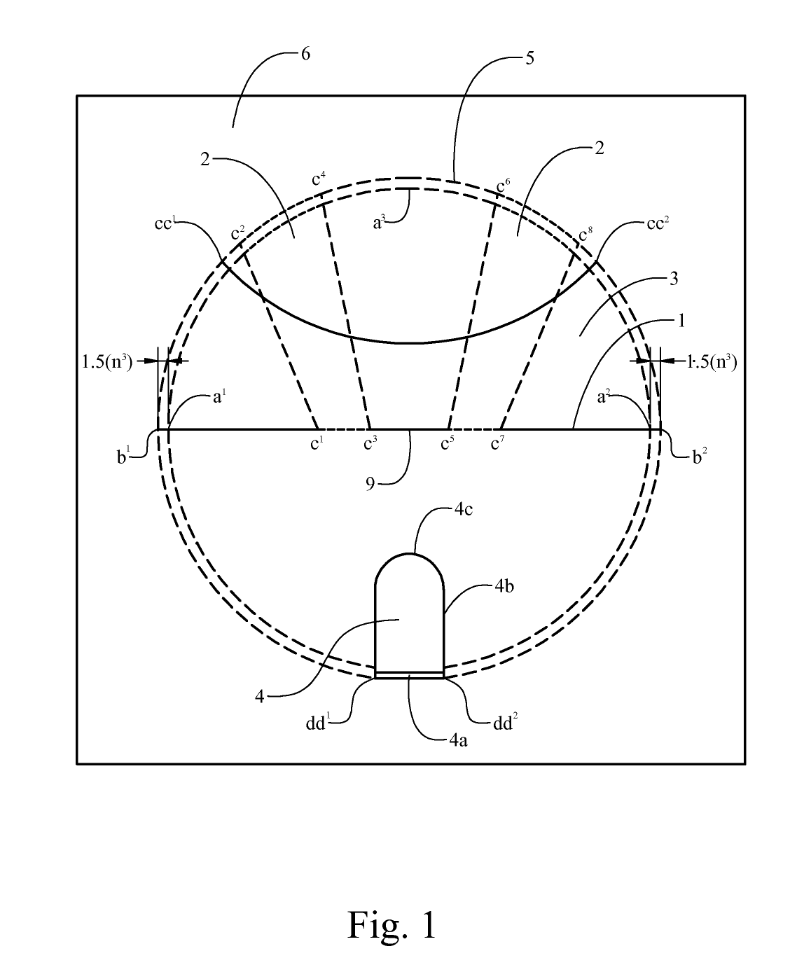

The present invention overcomes the prior art limitations and provides a rear loading media storage device for retaining media upon packaging when publicly displayed for sale. The preferred embodiment of the present invention 1 is shown in FIG. 1 ready to accept media for storage. Media includes various devices for transmitting information where the device has at least one flat planar surface. The following drawings and description refer to a compact disc, or CD, though other varieties of media are possible and anticipated, including Flash memory, Jumpdrives, gift cards, and the like. Generally the media has a partially planar, or flat, surface that fits snugly within the invention. The present invention has an arrangement of cuts, perforations, folds, and scores that relate directly to size and shape of the object contained within the device. The arrangement can also be called a location that includes the various cutlines, perforations, foldlines, and scores as described. The configuration arises from the width of the object, n1 or the distance from a1 to a2, the height of the object, n2 or the distance from a3 to a4, and the thickness of the object, n3.

A baseline 1 then extends through the apparent center of the object from two opposed keypoints b1, b2. The keypoints b1, b2 are located outwardly of the width of the object as denoted by points a1 and a2. The keypoints b1, b2 are each generally outwards a multiple of the thickness, n3, of the object. The thickness multiple is approximately 0.5 to 2.0 and preferably 1.5. The baseline 1 thus extends from keypoints b1 to b2 for the width of the object n1 and twice the thickness n3 with the multiple applied, preferably 1.5. FIG. 1 shows the baseline as being straight though the baseline may attain a curve as later shown. The curved baseline may have additional key points, as in c1, c3, c5, c7 which denote a transition regarding cuts and perforations of securing tabs. The baseline 1 may contain multiple keypoints corresponding to transitions between cuts and perforations.

Additional keypoints, c2, c4, c6, c8 are located above and outwardly from the baseline 1, or upon the perimeter, that correspond to the keypoints upon the baseline 1. The additional keypoints lie beyond the outer perimeter of the object secured in the device by a multiple of 1.5 times the thickness n3 of the object. Generally, the lines between the keypoints c2, c4, c6, c8 upon the perimeter to the corresponding keypoints c1, c3, c5, c7 on the baseline are cut lines. A set of key points, here c1, c2, c3, c4 and c5, c6, c7, c8 form bands that extend from the baseline outwardly to the width of the object plus 1.5 times the object thickness n3. For usage, the buyer of the device removes the bands following payment and then removes the object stored within.

Further additional keypoints, cc1 and cc2 are located upon the perimeter towards the baseline 1 and away from keypoints c2 and c8 respectively. The additional keypoints are located upon a radial line from the center approximately 1.5 times the thickness of the object outwardly from the outer edge of the object contained by the device of the present invention. Keypoints cc1 and cc2 represent the intersection of a partial arc with a radius of curvature from a center point above and outwardly from the center of the present invention. The radius of curvature generally forms an arc opposite the curvature of the present invention. Beneath the partial arc terminating at keypoints cc1 and cc2, the present invention may have a scoop as later shown. The scoop generally spans across the width of the object stored within the present invention leaving a portion of the object exposed.

Opposite the previous keypoints, the present invention has a tab 4 generally centered upon the present invention and opposite the bands 2 or scoop 3 above the baseline. The tab has a hinge located between the keypoints dd1 and dd2, generally outwardly 1.5 times the thickness of the object contained in the present invention. The tab has two side edges 4b, mutually parallel and spaced apart that extend inwardly into the present invention generally perpendicular to the hinge 4a. Opposite the hinge, the tab has a rounded top 4c that adjoins the side edges 4b. The side edges and rounded top are in cut lines so that the tab may partially fold and receive an edge of the object stored in the present invention.

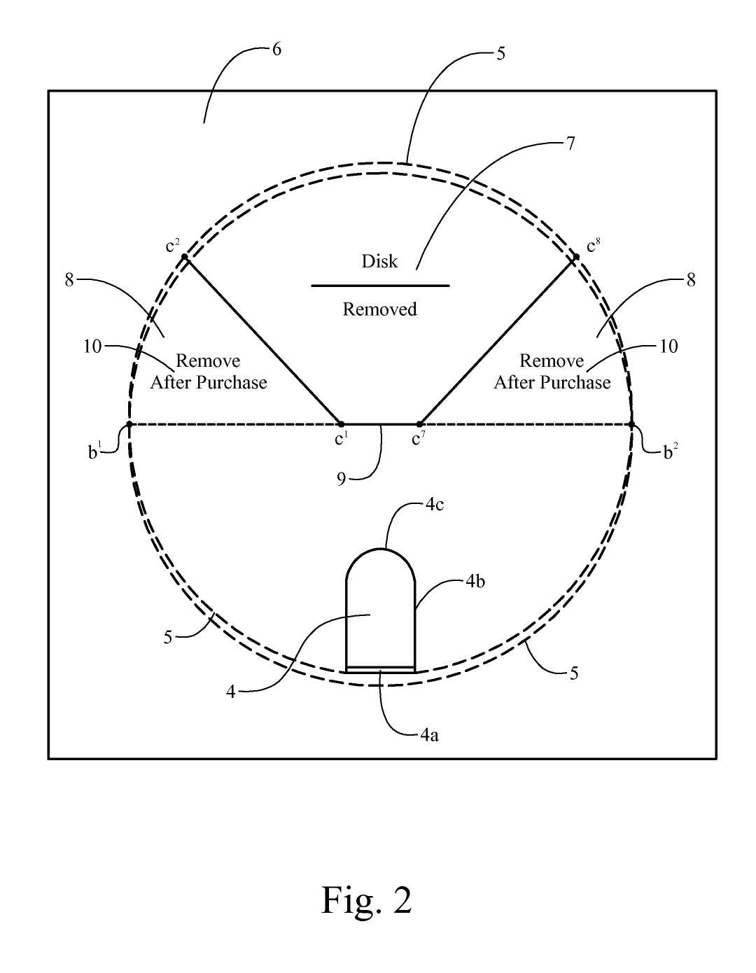

Turning from the theory and formulas based upon the thickness of an object, FIG. 2 shows a first embodiment, or arrangement, of the present invention. The first embodiment begins with a planar panel 6 here shown as rectangular though other shapes are foreseen and anticipated. The panel is generally a single sheet that has the cut lines, fold lines, and perforations that define the present invention and its ability to load objects upon the panel from the rear and to secure them. Upon the panel, the present invention illustrates the perimeter 5 of an object to be stored within the invention. The perimeter, here shown as round, is generally outwardly from the actual perimeter of the object by approximately 1.5 times the thickness of the object. As before, the invention has a baseline 1 extending through the center 9 of the invention collocated with the center of the object. Above the center, the invention has a warning 7 printed upon the material of the panel 6. The warning indicates to a merchant or buyer that an object once stored in the panel is no longer present. Here the warning is shown as “DISK REMOVED” though other similar indicia of notice or warning are foreseen.

As before, the baseline 1 has keypoints. For the first embodiment, the set of keypoints b1, c1, c2 define a chord 8 to the left of the center and the set of keypoints c7, c8, b2 define a second chord 8 to the right of the center. Both chords are approximately triangular in shape with the apex of the triangle located outwardly of the center upon the base line. The lines of the left chord 8 defined by c1 to b1, b1 to c2 are generally perforated and the line defined by c2 to c1 is generally a cut line. On the right chord 8, the lines defined by c7 to b2, b2 to c8 are generally perforated while the line from c8 to c7 is generally a cut line. Between the chords, the line from c1 to c7 is a cutline. Each chord 8 then has an instruction 10 printed thereupon, generally for the buyer after purchase of the object contained within the invention. Here the instruction is shown as “REMOVE AFTER PURCHASE” though other instructions are foreseen. As in FIG. 1, the first embodiment has a tab located below the center 9 and opposite the chords 8. The tab 4 has a somewhat rectangular shape of two side edges 4b, with a hinge 4a upon the perimeter of the object and a rounded top 4c opposite the hinge towards the center. The side edges and the rounded top are also cut lines so the tab separates into the panel 6.

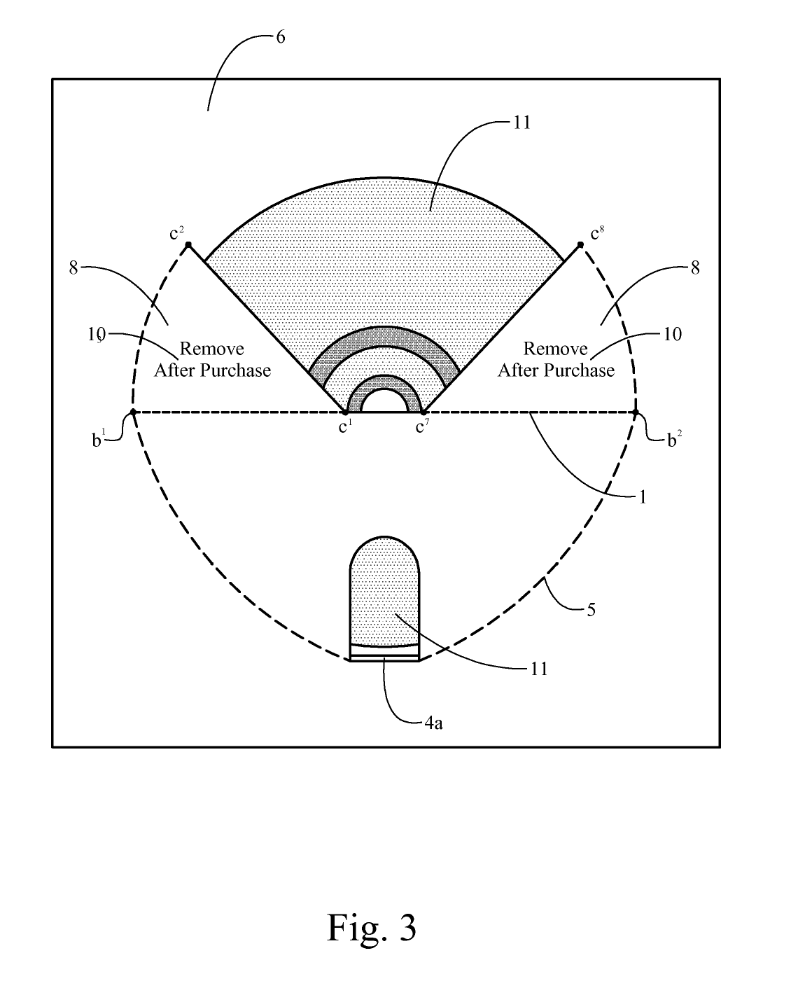

FIG. 3 shows the first embodiment in use where an object 11, here shown as a disc, is inserted into the invention, generally from the rear or below the plane of the panel 6. The object is passed through the cutlines c1 to c2 and c7 to c8 of the chords 8 with the tab 4 unfolded into the plane of the panel. With the object located within the invention, the tab 4 is then positioned behind the object with the edge of the object abutting the hinge 4a of the tab. The object thus remains secured upon at least three contact points for storage during display until after the time of sale of the object contained in the invention.

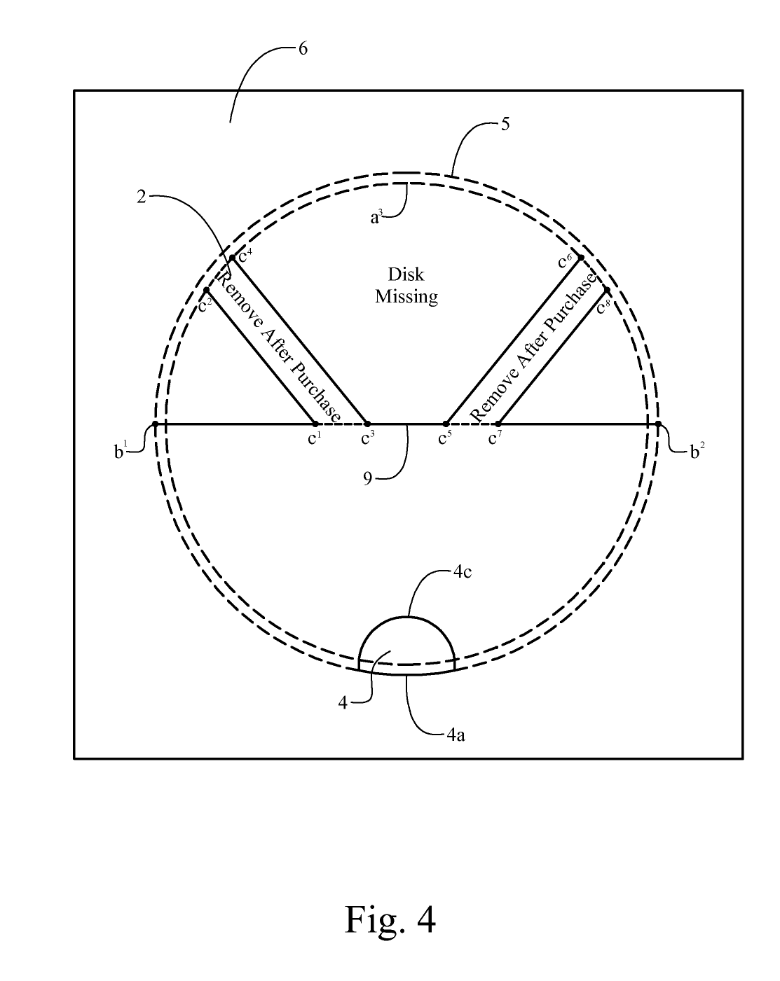

The second embodiment, or arrangement, of the present invention appears in FIG. 4 where as before a panel 6 is generally shown as a planar rectangular of a single sheet. The panel may have other forms though rectangular is shown to illustrate the invention. The figure shows the perimeter 5 generally 1.5 times the thickness of the object outside the actual perimeter of the object. The set of keypoints c1, c2, c3, c4 define a band 2 to the left of the center and the set of keypoints c5, c6, c7, c8, define a second band 2 to the right of the center. Both bands are approximately parallelogram in shape with the bases of the parallelogram generally perpendicular to a tangent upon the perimeter 5. The lines of the left band 2 defined by c1 to c3, c2 to c4 are generally perforated and the lines defined by c1 to c2, c3 to c4 are generally cut lines. On the right band 2, the lines defined by c5 to c7, c6 to c7 are generally perforated but the lines from c5 to c6, c7 to c8 are generally cut lines. Between the bands, the line from c3 to c5 is a cutline as are the lines outside of the bands b1 to c1, c7 to b2. Each band 2 then has an instruction 10 printed thereupon, generally for the buyer after purchase of the object inside the invention. Here the instruction is shown as “REMOVE AFTER PURCHASE” though other instructions are foreseen. Between the bands, the panel has a warning 7 printed or otherwise applied. As before, the second embodiment has a tab 4 located below the center 9 and opposite the bands 2. Here the tab 4 has a somewhat semicircular shape, with a hinge 4a upon the perimeter of the object and a rounded top 4c opposite the hinge towards the center. The rounded top is also a cut line allowing the tab to separate into the panel 6.

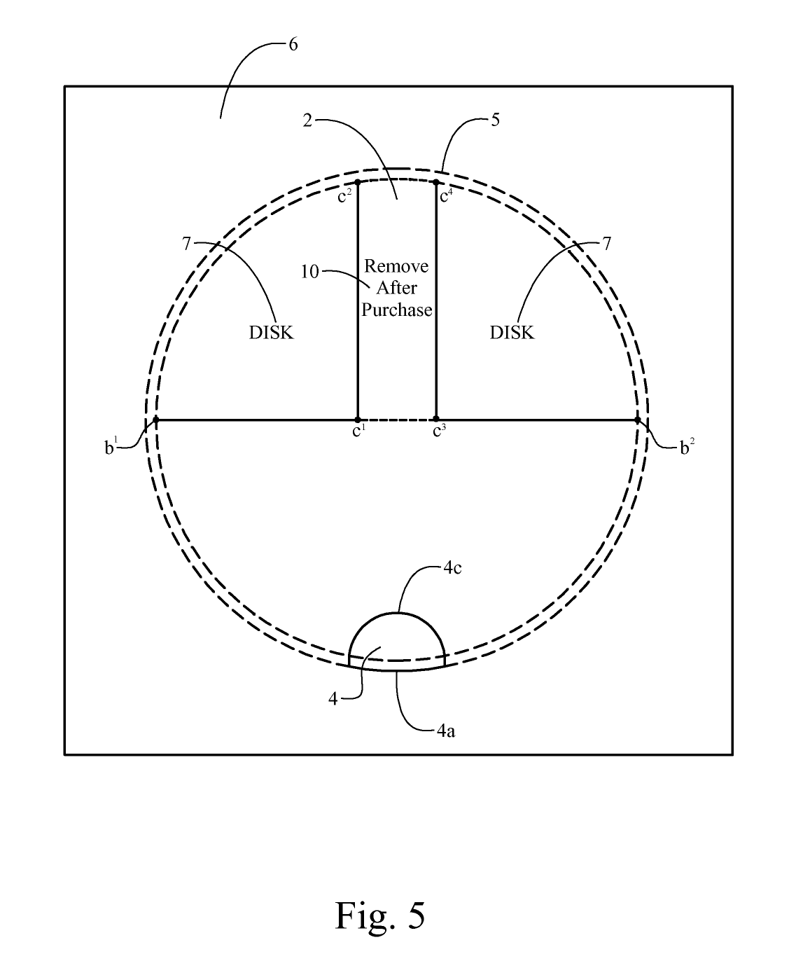

The third embodiment of the present invention appears in FIG. 5 where like in prior figures, a panel 6 is generally shown as a planar single sheet rectangle. The panel may have other forms though rectangular is shown to illustrate the invention. The figure shows the perimeter 5 generally 1.5 times the thickness of the object outside the actual perimeter of the object. The set of keypoints c1, c2, c3, c4 define a band 2 centered upon the panel and extending to the perimeter 5. The band is approximately rectangular in shape though one end, opposite the center 9, is rounded to accommodate the perimeter of the object once inserted into the invention. The lines of the band 2 defined by c1 to c3, c2 to c4 are generally perforated and the lines defined by c1 to c2, c3 to c4 are generally cut lines. Outwardly of the band, the lines b1 to c1, c3 to b2 are cut lines. The band 2 then has an instruction 10 printed thereupon, generally to guide the buyer in removing the object from the invention for usage following purchase of the object. Here the instruction is shown as “REMOVE AFTER PURCHASE” though other instructions are foreseen. Flanking the band 2 and within the perimeter 5 and above the base line 1, the panel has at least one warning 7 printed or otherwise applied, and here two symmetrical warnings are shown. As before, the third embodiment has a tab 4 located below the center 9 and inline with the band 2. Here the tab 4 has a somewhat semicircular shape, with a hinge 4a upon the perimeter of the object and a rounded top 4c opposite the hinge towards the center. The rounded top is also a cut line allowing the tab to separate into the panel 6.

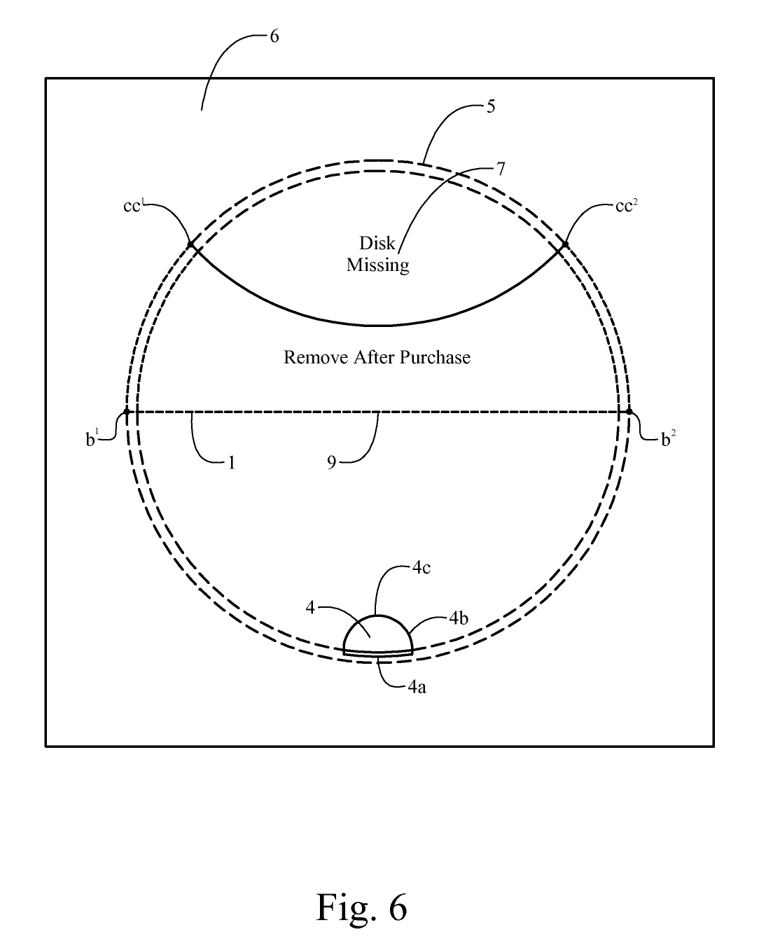

The fourth embodiment of the invention takes form in FIG. 6. A planar panel 6 here shown as rectangular, but other shapes are anticipated, is generally a single sheet that has the cut lines, fold lines, and perforations that define the fourth embodiment and its ability to load objects upon the panel from the rear and to secure them. Upon the panel, the present invention illustrates the perimeter 5 of an object to be stored within the invention. The perimeter, here shown as round, is generally outwardly from the actual perimeter of the object by approximately 1.5 times the thickness of the object. As before, the invention has a baseline 1 extending through the center 9 of the invention collocated with the center of the object.

As before, the fourth embodiment has keypoints b1, b2, cc1, and cc2 where keypoints b1, b2 are the ends of the baseline 1 here shown laterally upon the panel 6. Above the baseline, keypoints, cc1 and cc2 are located upon the perimeter partially towards the intersection of a radius with a tangent parallel to the baseline. The additional keypoints cc1 and cc2 are located upon radial lines from the center approximately 1.5 times the thickness of the object outwardly from the outer edge of the object contained by the device of the present invention. Keypoints cc1 and cc2 represent the intersection of a partial arc with a radius of curvature from a center point above and outwardly from the center of the present invention. The radius of curvature generally forms an arc opposite the curvature of the present invention. Beneath the partial arc terminating at keypoints cc1 and cc2, the present invention has the scoop 3 that spans across the width of the object stored within the present invention leaving a portion of the object exposed. The arc from cc1 to cc2 is generally a cut line while the lines from b1 to b2, b1 to cc1 and b2 to cc2 are perforated lines.

As in prior embodiments, the fourth embodiment has a tab located below the center 9 and opposite the scoop 3. The tab 4 has a somewhat rectangular shape of two side edges 4b, with a hinge 4a upon the perimeter of the object and a rounded top 4c opposite the hinge towards the center. The side edges and the rounded top are also cut lines so the tab bends inwardly behind the panel 6 to accept an edge of an object stored in the embodiment.

Above the center 9 and the scoop 3, the invention has a warning 7 printed upon the material of the panel 6. The warning indicates to a merchant or buyer that an object once stored in the panel is no longer present. Here the warning is shown as “DISK MISSING” though other similar indicia of notice or warning are foreseen. The scoop then has an instruction 10 printed thereupon, generally for the buyer after purchase of the object contained within the invention. Here the instruction is shown as “REMOVE AFTER PURCHASE” though other instructions are foreseen.

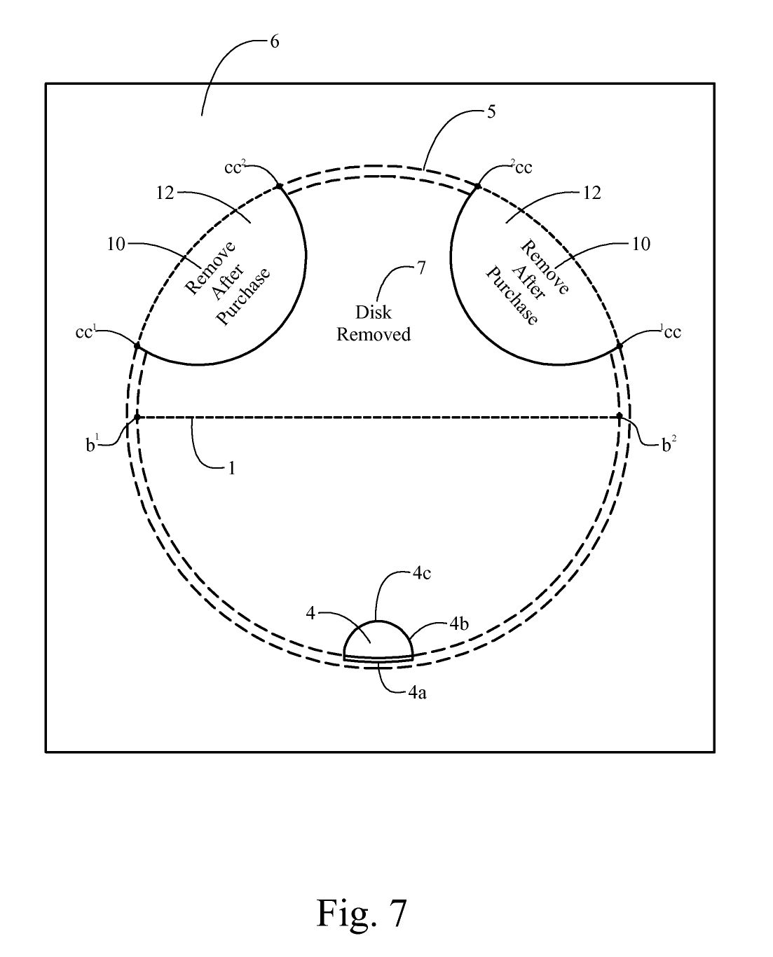

FIG. 7 shows the fifth embodiment of this invention where two flaps 12 secure the upper edge of an object within the invention. Beginning with a planar panel 6 here shown as rectangular, but other shapes are anticipated, a single sheet has the cut lines, fold lines, and perforations that define the parts of the fifth embodiment with the ability to load objects upon the panel from the rear. Upon the panel, the present invention shows in phantom the perimeter 5 of an object to be stored within the invention. The perimeter, here shown as round, is generally outwardly from the actual perimeter of the object by approximately 1.5 times the thickness of the object. As before, the invention has a baseline 1 extending through the center 9 of the invention collocated with the center of the object.

This embodiment has keypoints b1, b2, cc1, cc2, cc3, and cc4 where keypoints b1, b2 are the ends of the baseline 1 here shown laterally upon the panel 6. Above the baseline, keypoints, cc1 and cc2, and cc3 and cc4 are symmetrically located upon the perimeter partially towards the intersection of a radius with a tangent parallel to the baseline. The keypoints cc1, cc2, cc3 and cc4 are located upon radial lines from the center approximately 1.5 times the thickness of the object outwardly from the outer edge of the object. Keypoints cc1 and cc2 represent the intersection of the perimeter 5 and a partial arc extending from a radius of curvature upon a center point above, outwardly, and to the left from the center of the present invention. The radius of curvature generally forms an arc opposite the curvature of the perimeter. Within the partial arc terminating at keypoints cc1 and cc2, the present invention has the left flap 12 that spans partially into the width and into the height of the object stored within the present invention leaving a portion of the object exposed. Similarly, keypoints cc3 and cc4 represent the intersection of the perimeter 5 and a partial arc extending from a radius of curvature upon a center point above, outwardly, and to the left from the center of the present invention. Keypoints cc3 and cc4 are generally opposite the prior keypoints cc1, cc2. The radius of curvature generally forms an arc opposite the curvature of the perimeter. Within the partial arc terminating at keypoints cc1 and cc2, the present invention has the right flap 12 that spans partially into the width and into the height of the object stored within the present invention leaving a portion of the object exposed. The left flap and the right flap are generally symmetric about a radius perpendicular to a tangent where the tangent is parallel to the baseline. The arcs from cc1 to cc2, and cc3 to cc4 are generally cut lines while the lines from b1 to b2, cc1 to cc2, and cc3 to cc4 are perforated lines.

As before, the fifth embodiment has a tab located below the center 9 and the flaps 12. The tab 4 has a somewhat rectangular shape of two side edges 4b, with a hinge 4a upon the perimeter of the object and a rounded top 4c opposite the hinge towards the center. The side edges and the rounded top are also cut lines so the tab bends inwardly behind the panel 6 to accept an edge of an object stored in the embodiment.

Above the center 9 and between the flaps 12, the invention has a warning 7 printed upon the material of the panel 6. The warning is concealed by an object stored within the invention and indicates to a merchant or buyer that an object once stored in the panel is no longer present when the warning is seen. Here the warning is shown as “DISK REMOVED” though other similar indicia of notice or warning are foreseen. Each flap 12 then has an instruction 10 printed thereupon, generally for the buyer after the purchase of the object. Here the instruction is shown as “REMOVE AFTER PURCHASE” which directs the buyer to tear off the flaps at the perforations while the baseline still permits storage of the object.

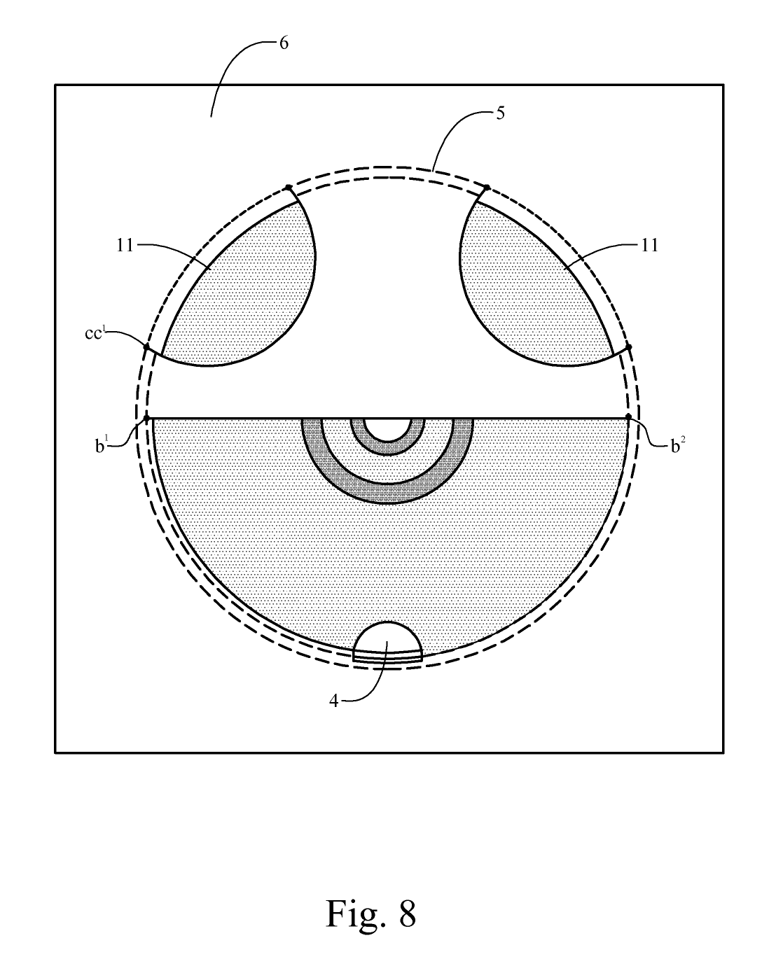

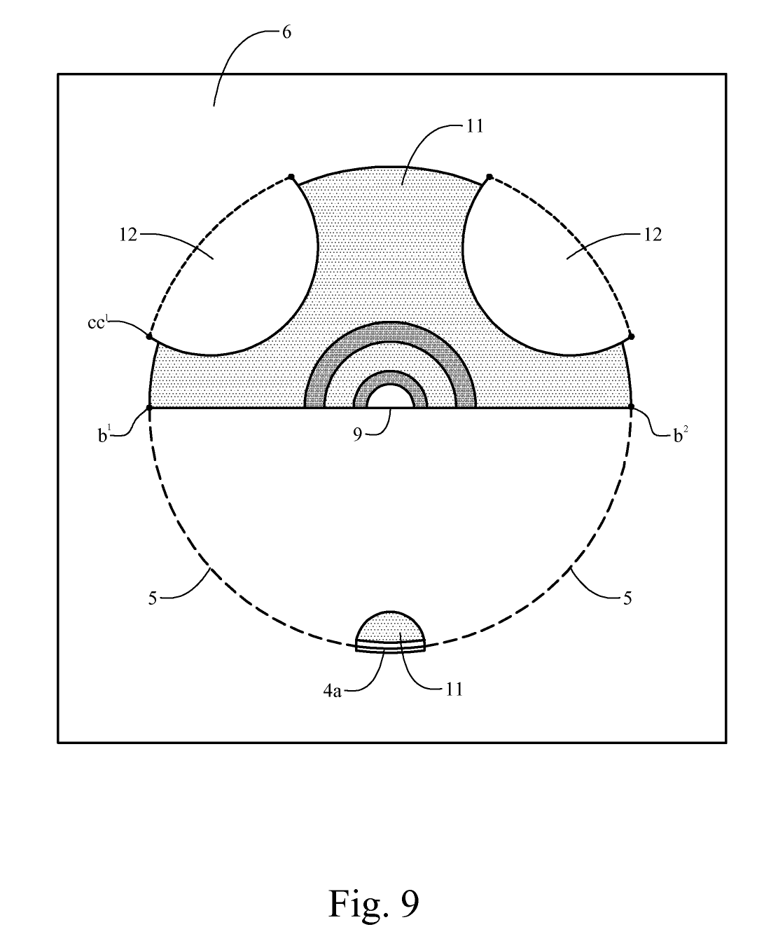

The fifth embodiment holds an object 11, here shown as a disk, with the panel 6 shown on the reverse face in FIG. 8. The disk is inserted upon the obverse face of the panel, through the baseline 1, and beneath the flaps 12 previously described. Two curved chord like portions of the disk 11 are now seen. The tab 4 is then placed upon the disk, on the opposite side of the disk as the flaps to secure the disk at three points and thus retain it upon the panel 6. FIG. 9 shows the obverse face of the fifth embodiment where an object 11 is inserted beneath the flaps 12, through the baseline 1, and then in front of the tab 4 with the hinge 4a upon the perimeter 5 below the center 9. The two flaps 12 are now seen and ready for the consumer to remove after purchase. The tab 4 is then placed behind the disk, opposite the flaps to secure the disk at three points upon the panel 6.

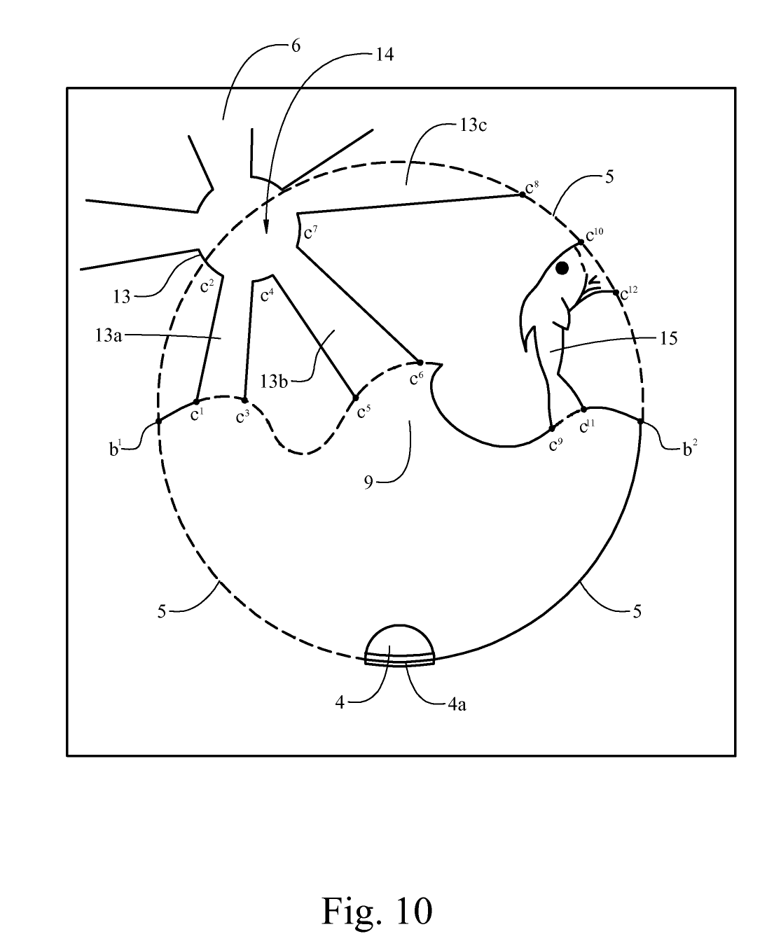

And the sixth embodiment takes form in FIG. 10 as an artistic, but securing, means of retaining an object 11 upon the panel 6. The panel 6 is generally a planar rectangular single sheet. The panel may have other forms though rectangular is shown to illustrate the invention. The figure shows the perimeter 5 generally 1.5 times the thickness of the object outside the actual perimeter of the object. The invention has a center 9 generally located between keypoints b1 to the left and b2 to the right at the perimeter 5. Unlike other embodiments, this baseline has a sinusoidal like shape to simulate water. Keypoints c1, c3, c5, c6, c9 and c11 are located upon the baseline, keypoints c8, c10, and c12 are located upon the perimeter, and keypoints c2, c4, c7 are located near the perimeter as shown in FIG. 10. The set of keypoints c1, c2, c3, c4, c5, c6, c7, and c8 define a stylized band 13 to the left of the center and the set of keypoints c9, c10, c11, c12 define a second stylized band 15 to the right of the center. The stylized band 13 has a juncture 14 located upon the perimeter above the center and towards the left of a radius intersecting a tangent parallel to the baseline. The juncture receives multiple bands, where bands are defined by the groups of keypoints c1, c2, c3, c4 and c4, c5, c6, c7 and c7, c8. These bands are generally rectangular though extend radially from the juncture 14. The radius of the bands is dissimilar to the radius of the perimeter. The second stylized band 15 here has a shape of a fish defined by the lines between c9, c10, c11, and c12. Though a fish has been described, other artistic shapes are anticipated. The lines of the left band 13 defined by b1 to c1, b1 to c2, c3 to c4, c4 to c5, c6 to c7, c7 to c8 are generally cut lines, those lines as c1 to c3 and c5 to c6 are generally perforated. For the right band 14, the lines defined by c9 to c11, c10 to c12 are generally perforated but the lines from c9 to c10, c11 to c12 are generally cut lines. Between the bands, the line from c6 to c9 is a cutline as are the lines outside of the bands b1 to c1, c11 to b2. As before, the sixth embodiment has a tab 4 located below the center 9 and opposite the bands 2. Here the tab 4 has a somewhat semicircular shape, with a hinge 4a upon the perimeter of the object and a rounded top 4c opposite the hinge towards the center. The rounded top is also a cut line allowing the tab to separate behind the panel 6.

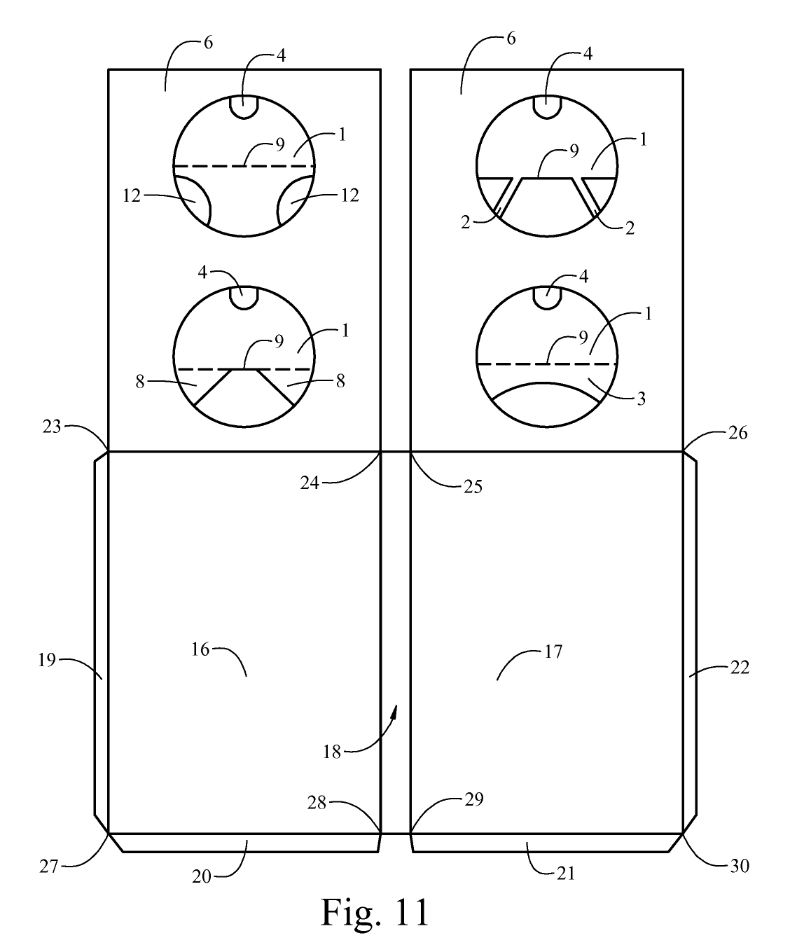

Bring together some of the previous embodiment, FIG. 11 shows packaging for media in flat form. The packaging has generally two halves partially connected by two parallel living hinges upon a hinge panel 18. The left half has a panel 6 showing the 5th embodiment of FIG. 7 where two flaps 12 and a tab 4 cooperate to secure a CD and the 1^{st} embodiment of FIG. 2 where a tab 4 and two chords 8 secure another CD. Each embodiment is spaced apart along the length of the panel. The panel 6 extends from the left backing 16 here shown as rectangular and of similar length and width as the panel. The right half also has a panel 6 spaced away from the panel of the left half, generally the width of the hinge panel 18. The panel 6 shows the 2^{nd} embodiment of FIG. 4 where two bands 2 and a tab 4 cooperate to secure a CD and the 4^{th} embodiment of FIG. 6 where a tab 4 and a scoop 3 hold a CD within the panel. Each embodiment is spaced apart along the length of the panel. The panel 6 extends from the right backing 17 here shown as rectangular and of similar length and width as the panel.

The left panel 6 adjoins the left backing 16 along a fold line 23-24 extending perpendicular to the length of the panel and backing. The left backing has a longitudinal tab 19 extending upon the longitudinal edge, outwardly of the invention from the fold line as at 23 to the corner as at 27. The longitudinal tab extends from the fold line 23-27 along the left backing. Opposite the panel, the left backing has the lateral tab 20 extending upon the lateral edge and along the fold line 27-28. The lateral tab 20 ends proximate the hinge panel as at 28. Now the right panel 6 adjoins the right backing 17, spaced away from the left panel by the hinge panel, and along a fold line 25-26 extending perpendicular to the length of the panel and backing. Fold line 25-26 and 23-24 are generally collinear. The right backing has a longitudinal tab 22 extending upon the longitudinal edge, outwardly of the invention from the fold line as at 26 to the corner as at 30. This longitudinal tab is generally opposite the longitudinal tab upon the left backing 16. On the right backing, the longitudinal tab extends from the fold line 26-30 along the right backing. Opposite the panel, the right backing has the lateral tab 21 extending upon the lateral edge and along the fold line 29-30 outwardly from the hinge panel as at 29. The fold lines 27-28 and 29-30 are generally collinear and the lateral tabs 20, 21 are separated by the width of the hinge panel.

In use, CDs are placed in each located opening of the arrangements on the panels 6. Then the panels are folded along lines 23-24, 25-26. The panels are secured to the longitudinal tabs and the lateral tabs folded beneath portions of the perimeter of the panels. The right backing is then folded upon the left backing along line 25-29. The hinge panel 18 spaces the right backing above the left backing to accommodate the thickness of the CD or other media placed within the panels here of the present invention.

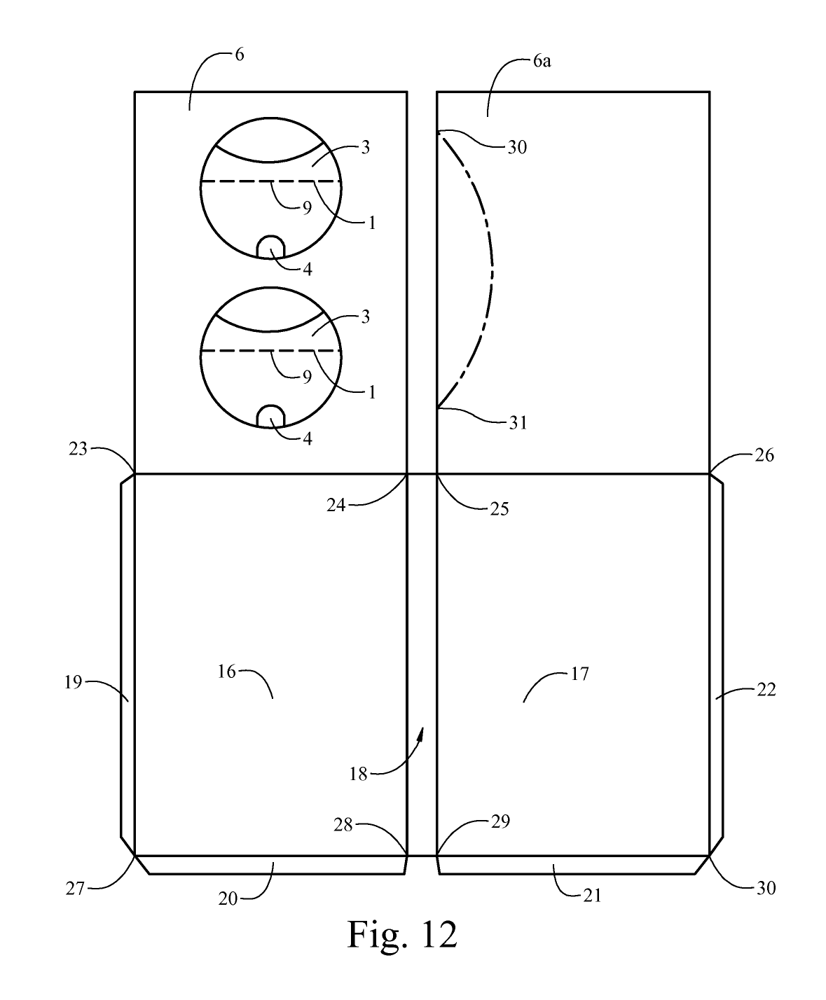

Similar to the preceding embodiment, FIG. 12 shows packaging for two media in flat form where the packaging also includes a folder for paper corresponding to the media. The packaging has generally two halves partially connected by two spaced apart and mutually parallel living hinges upon a hinge panel 18. The left half has a panel 6 showing two usages of the 4^{th} embodiment of FIG. 6 where a tab 4 and a scoop 3 hold a CD or other media within the panel. Each scoop is spaced apart along the length of the panel. The panel 6 extends from the left backing 16, here rectangular and of similar length and width as the panel. The right half also has a panel 6a spaced away from the panel of the left half, generally the width of the hinge panel 18. The panel 6a extends from the right backing 17 here shown as rectangular and of similar length and width as the left panel. The right panel though has an arcuate score from points 30 to 31 along the inside edge of the right panel.

As before, the left panel 6 adjoins the left backing 16 along a fold line 23-24 extending perpendicular to the length of the panel and backing. The left backing has a longitudinal tab 19 extending upon the longitudinal edge, outwardly of the invention from the fold line as at 23 to the corner as at 27. The longitudinal tab extends from the fold line 23-27 along the left backing. Opposite the panel, the left backing has the lateral tab 20 extending upon the lateral edge and along the fold line 27-28. The lateral tab 20 ends proximate the hinge panel as at 28. Now the right panel 6 adjoins the right backing 17, spaced away from the left panel by the hinge panel, and along a fold line 25-26 extending perpendicular to the length of the panel and backing. Fold line 25-26 and 23-24 are generally collinear. The right backing has a longitudinal tab 22 extending upon the longitudinal edge, outwardly of the invention from the fold line as at 26 to the corner as at 30. This longitudinal tab is generally opposite the longitudinal tab upon the left backing 16. On the right backing, the longitudinal tab extends from the fold line 26-30 along the right backing. Opposite the panel, the right backing has the lateral tab 21 extending upon the lateral edge and along the fold line 29-30 outwardly from the hinge panel as at 29. The fold lines 27-28 and 29-30 are generally collinear and the lateral tabs 20, 21 are separated by the width of the hinge panel.

In use, CD or other media are placed in each cut line located on the left panel 6. Then the panels 6. 6a are folded along lines 23-24, 25-26. The panels are secured to the longitudinal tabs and the lateral tabs folded beneath portions of the perimeter of the panels. The right backing is then folded upon the left backing along line 25-29. The hinge panel 18 spaces the right backing above the left backing to accommodate the thickness of the CD or other media placed within the panels here of the present invention. Once the packaging is assembled, the consumer can remove the portion of the right panel bounded by points 30 to 31. The right panel then has a scoop shaped opening extending longitudinally. The scoop like opening then allows for ready insertion and removal of papers and other planar materials by the consumer in a pocket formed by the right panel upon the right backing.

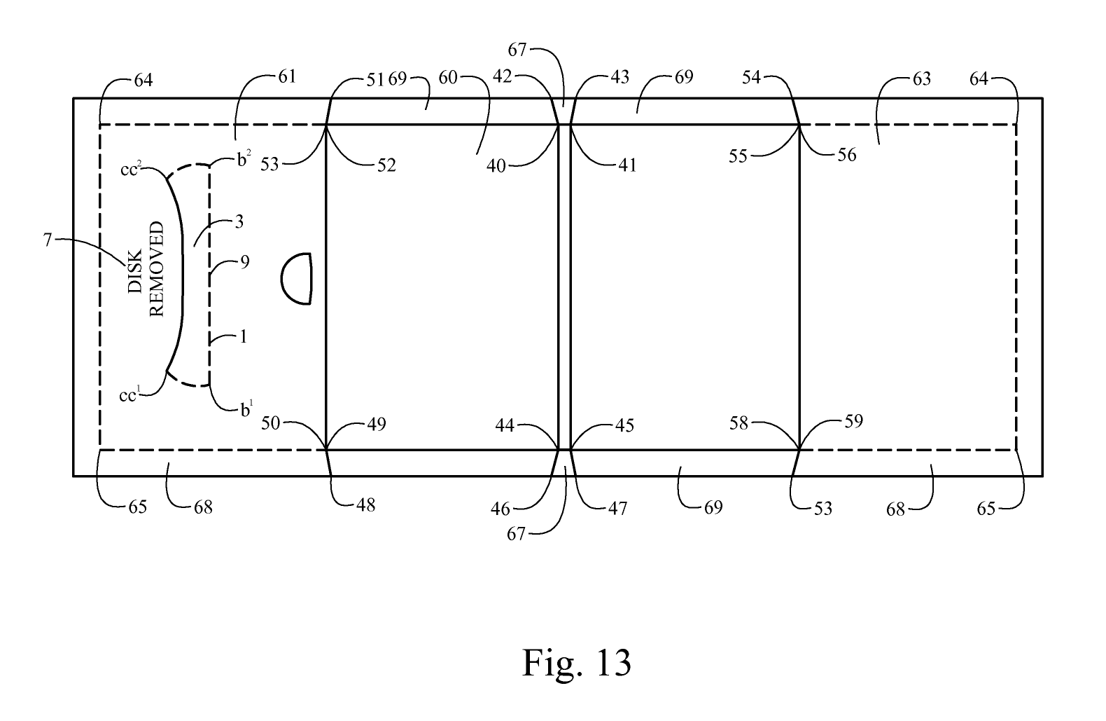

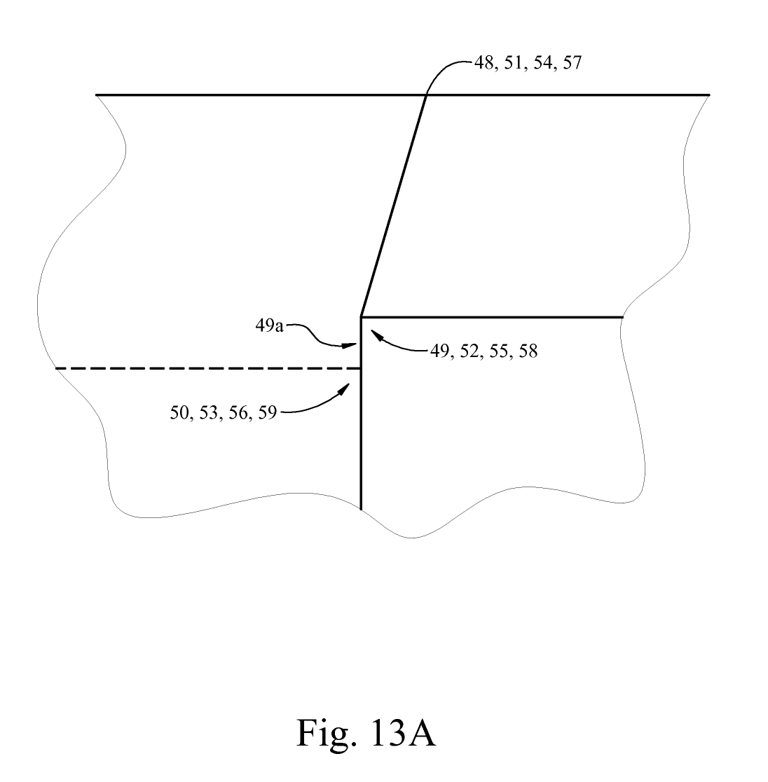

Turning to further alternate embodiments, FIGS. 13-19 show mailers having various locations and scoring patterns. Generally, the mailers have similar fold patterns and perimeter scoring to transform from flat form into a mailable article with a card like shape and dimensions suitable for the mails. FIG. 13 will be fully described regarding its fold patterns and perimeter scoring while remaining embodiments will incorporate the description of FIG. 13. The location and scoring patterns for each storage location in FIGS. 13-19 will be described separately.

FIG. 13 shows a mailer in flat form that can be made upon customary printing equipment or a user can create the mailer using a home computer and printing equipment. The mailer has a general size of 8½ inches by 22 inches. The mailer has its fold lines, scoring lines, and perforations die cut upon one surface and the user prints upon the opposite surface. FIGS. 13-19 show the die cut surface upwardly. Each mailer, beginning with FIG. 13, has an inside back cover 61 sharing a common hinge with a back cover 60 that connects to a spine 18 which then shares a common hinge with a front cover 62 that then has a common hinge with an inside front cover 63 here shown left to right in FIG. 13. The spine is commonly contiguous with the back cover and the front cover and the hinge functions as a living hinge. Each of these covers has a generally rectangular shape with the long axis of the shape being perpendicular to the long axis of the mailer when flat. The back cover 60 and the front cover 62 join to a spine 18 upon living hinges. Upon the back cover, the living hinge extends from the point 40 to the opposite point 44 and on the front cover, the living hinge extends from the point 41 to the opposite point 45. The living hinges are generally parallel and spaced apart to accommodate the thickness of a CD, gift card, or other media. Outwardly from the spine, the mailer has two opposite chads 67. One chad is formed between points 40, 41, 42, and 43 and the other chad is between points 44, 45, 46, and 47. Points 42, 43, 46, and 47 are upon the perimeter of the mailer. The lines 42, 40, 41, 43 and 46, 44, 45, 47 are cut lines so that the user can remove the chad prior to folding the mailer into a card shape. Outwardly from the chad 67 and perpendicular to the spine 18, the back cover 60 and the front cover 62 each have a tab 69 upon each end, thus two tabs per cover. The tabs have a generally parallelogram shape with beveled edges to ease assembly of the mailer into a card. The back cover has tabs defined by points 40, 42, 51, 52 and 44, 46, 48, 49. The tabs have fold lines from 40 to 52 and 44 to 49 and cut lines from 51 to 52 and 48 to 49. While the front cover has tabs defined by points 41, 43, 54, 55, and 45, 47, 57, 58. These tabs have fold lines from 41 to 55 and 45 to 58 and cut lines from 54 to 55 and 57 to 58. The cut lines provide a beveled shape to the tabs while the fold lines permit the tabs to fold inwardly for assembly of the mailer into a card.

The back cover joins to the inside back cover 61 along a living hinge from points 50 to 53. Then the front cover also joins to the inside front cover 63 on its living hinge from points 56 to 59. Points 50, 53, 56 and 59 are recessed inwardly from the nearby points, or corners, 49, 52, 55, 58 respectively. By recessing points 50, 53, 56 and 59 from their respective corners, the recipient of a mailer does not feel a perforation or an edge when the inside front cover folds upon the front cover and the inside back cover folds upon the back cover. The recess as is at 49a is approximately 1/64 inch to approximately ¼ inch with a 1/16 inch recess being preferable. The relationship of the points, their respective corners, and their recesses is shown in the detail FIG. 13a.

Then outwardly from the tabs 69 upon the front cover and outside the corners 56, 59, the inside front cover has a strip chad 68. The strip chad has a width slightly more than the width of a tab 69, approximately the tab width plus the recess. The strip chad can separate from the inside front cover along a perforation defined by the line from points 56 to 64 to 65 to 59. Points 64, 65 are the inside corners of the strip chad and are generally located proximate the corners of the front cover outward from the tabs.

In a mirror image to the front cover, the back cover and outside the corners 50, 53, the inside back cover also has a strip chad 68. The strip chad has a width slightly more than the width of a tab 69, approximately the tab width plus the recess. The strip chad can separate from the inside back cover along a perforation defined by the line from points 53 to 64 to 65 to 50 and generally attains a C shape when the strip chad separates. Points 64, 65 are the inside corners of the strip chad and are generally located proximate the corners of the back cover outward from the tabs.

In the particular embodiment shown in FIG. 13, the inside back cover has a location for one CD as seen in FIG. 6. The perimeter of the location, generally the round shape of a CD is generally outwardly from the actual perimeter of the object by approximately 1.5 times the thickness of the object. As before, the invention has a baseline 1 extending through the center 9 of the invention collocated with the center of the object. As before, this embodiment has keypoints b1, b2, cc1, and cc2 where keypoints b1, b2 are the ends of the baseline 1 here shown longitudinally upon the inside back cover 61. To the left of the baseline, keypoints cc1 and cc2 are located upon the perimeter partially towards the intersection of a radius with a tangent parallel to the baseline. The additional keypoints cc1 and cc2 are located upon radial lines from the center approximately 1.5 times the thickness of the object outwardly from the outer edge of the object contained by the device of the present invention. Keypoints cc1 and cc2 represent the intersection of a partial arc with a radius of curvature from a center point above and outwardly from the center of the present invention. The radius of curvature generally forms an arc opposite the curvature of the present invention. Beneath the partial arc terminating at keypoints cc1 and cc2, the present invention has the scoop 3 that spans across the width of the object stored within the present invention leaving a portion of the object exposed. The arc from cc1 to cc2 is generally a cut line while the lines from b1 to b2, b1 to cc1 and b2 to cc2 are perforated lines.

As in prior embodiments, this embodiment has a tab located to the right of the center 9 and opposite the scoop 3. The tab 4 has a somewhat rectangular shape of two side edges 4b, with a hinge 4a upon the perimeter of the object and a rounded top 4c opposite the hinge towards the center. The side edges and the rounded top are also cut lines so the tab bends inwardly behind the panel 6 to accept an edge of an object stored in the embodiment.

Outwardly from the center 9 and the scoop 3, the invention has a warning 7 printed upon the material of the inside back cover 61. The warning indicates to a merchant or buyer that an object once stored in the panel is no longer present. Here the warning is shown as “DISK MISSING” though other similar indicia of notice or warning are foreseen.

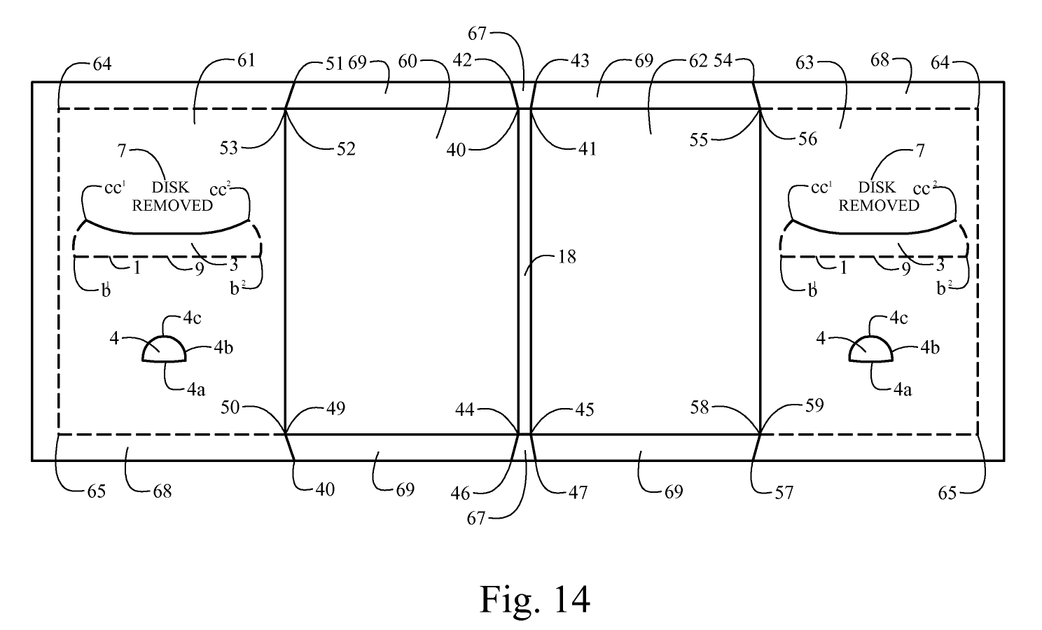

As FIG. 13 is fully described, the next embodiment in FIG. 14 has two locations for storing a CD or other media. In this embodiment, the locations are located in the inside back cover 61 and the inside front cover 63, generally symmetric about the spine 18. Each location has a scoop 3 oriented laterally upon the cover with a warning 7, tab 4, and scoring as previously described. Generally each location has a portrait type layout.

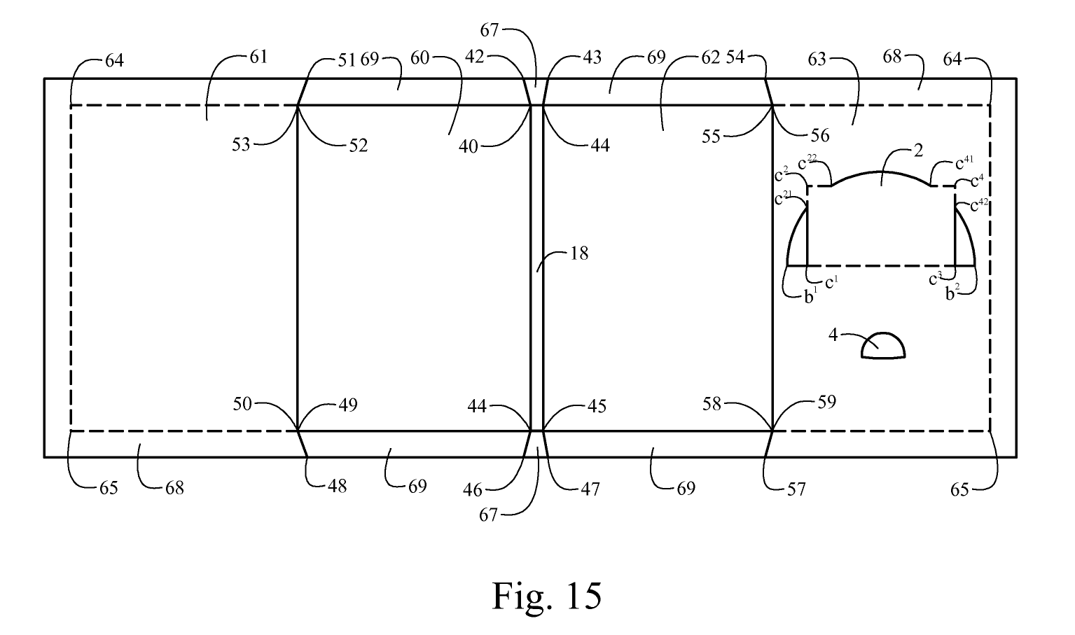

Then FIG. 15 shows the next embodiment of the mailer with one location for storing a CD or other media. This embodiment has the location upon the inside front cover 63. The location has a tab 4 as described previously and a band 2 opposite the tab. The CD or other media sticks outwardly from the band. This band 2 though has a shape similar to that of a business card in landscape orientation. The band has cut lines from c1 to c21, c22 to c41 curved to follow the CD, and c43 to c3. Cut lines c1 to c21 and c43 to c3 are mutually parallel and parallel to the width of the mailer. Outside of the band, the location has cut lines from b1 to c21, b1 to c1, c3 to b2, and b2 to c42. The business card of the band is generally defined by the points c1, c21, c2, c22, c41, c4, c42, and c3 with c1, c2, c4, c3 denoting the corners of the business card. The band has perforations from c1 to c3, c21 to c2 to c22, c42 to c4 to c41, and those perforations from c22 to c41 are spaced apart and parallel to those from c1 to c3. Once the mailer arrives to a recipient, the recipient opens the mailer and removes the CD as desired then separates the business card or band 2 from the perforations as described.

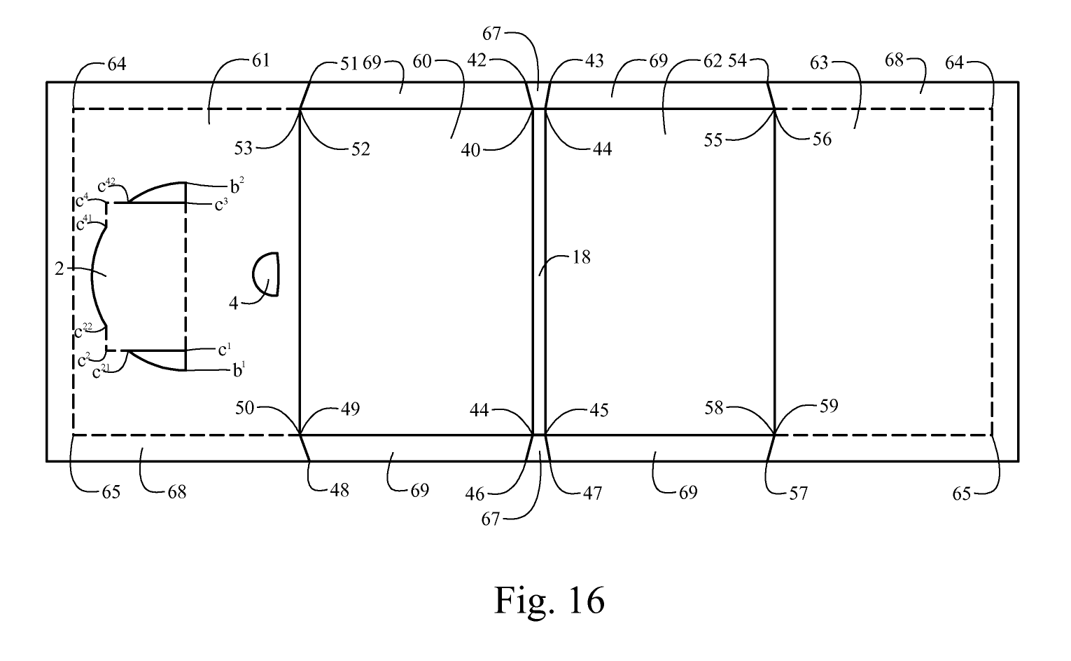

Akin to FIG. 15, FIG. 16 shows another mailer embodiment with a business card. This mailer has one location for storing a CD or other media and providing a business card, here upon the inside back cover 61. The location has a tab 4 as described previously and generally upon the longitudinal axis of the mailer and a band 2 opposite the tab. The CD or other media sticks outwardly from the band. This band 2 though has a shape similar to that of a business card in portrait orientation, short side up. The band has cut lines as before from c1 to c21, c22 to c41 curved to follow the CD, and c43 to c3. Cut lines c1 to c21 and c43 to c3 are mutually parallel and parallel to the width of the mailer. Outside of the band, the location has cut lines from b1 to c21, b1 to c1, c3 to b2, and b2 to c42. The business card of the band has a border defined by the points c1, c21, c2, c22, c41, c4, c42, and c3 with c1, c2, c4, c3 denoting the corners of the business card. The band has perforations from c1 to c3, c21 to c2 to c22, c42 to c4 to c41, and those perforations from c22 to c41 are spaced apart and parallel to those from c1 to c3. Once the mailer arrives to a recipient, the recipient opens the mailer and removes the CD and the business card or band 2 as desired from the perforations as described.

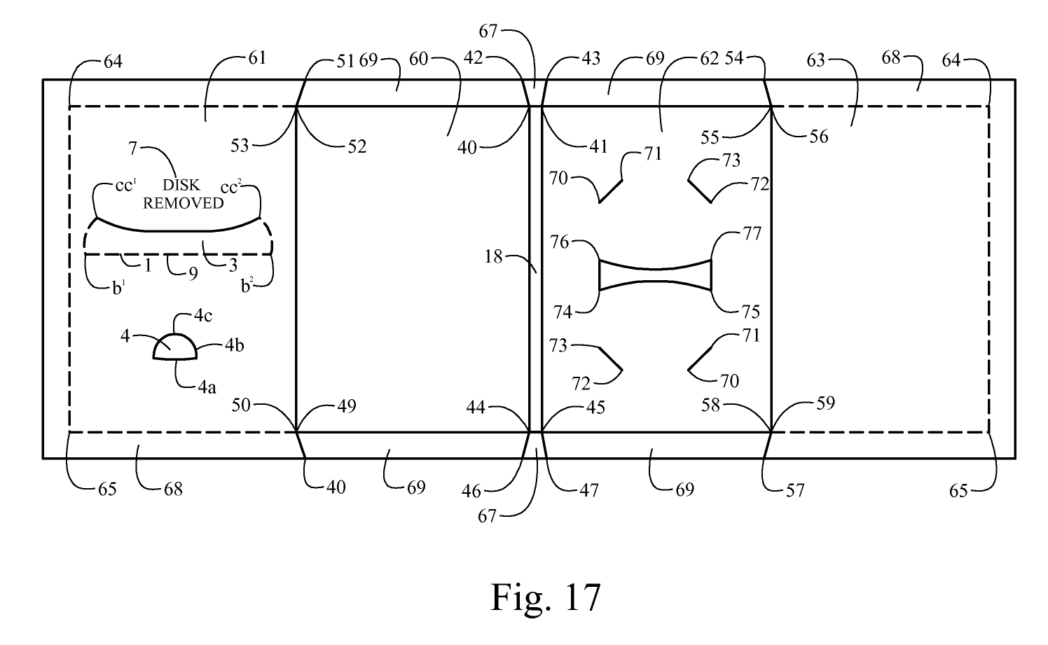

The mailer has an embodiment with separate CD holder and business card holders in FIG. 17. This embodiment has a CD location in the inside back cover 61 generally as described in FIG. 14. On the front cover 62 though, this mailer has a portrait business card holder. This holder begins with a strap extending from the points shown as 74, 75, 76, and 77. The strap has a generally elongated form, here shown as rectangular with concave long edges. The edges between points 74 and 75, and 76 and 77 are cut lines. Upon cutting those edges, a user slips a business card beneath the strap and centers it. The corners of the business card then secure into slits defined by the lines between 70 and 71, 72 and 73. This embodiment has four spaced apart slits in two pairs. The slits are located spaced apart from the strap and upon an imaginary line drawn from the short edges of the strap as in 74 to 76 and 75 to 77. The slits have a forty five degree orientation from the longitudinal axis of the mailer. The slits have a spaced to accommodate the length of a business card, not shown, that a person can insert into the mailer prior to mailing.

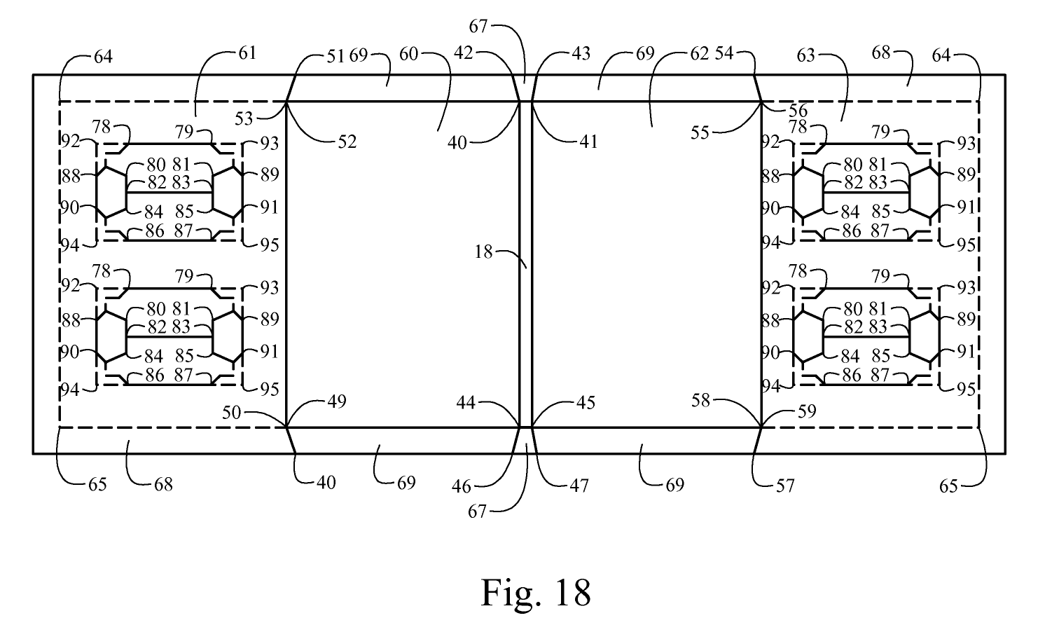

Beyond CD and business cards, the mailer can hold other items, including gift cards. The mailer embodiment in FIG. 18 holds four gift cards where the inside back cover 61 and the inside front cover 63 each have two locations to secure a gift card. As the locations are generally symmetrical and located symmetrically, one location will be described. The inside back cover has two locations where a location has mutually parallel and spaced apart fold lines from the points denoted 78 to 79 and 86 to 87. Centered between those fold lines, a location has a cut line from 82 to 93. The portions of the mailer between the cut line and the fold lines are a leaf behind which locates a gift card. This cut line allows a recipient to grasp a leaf and open it outwardly from the mailer to reveal the gift card beneath. Upon each end of the cut line 82 to 83, the location has two tabs of a somewhat hexagonal shape noticeably less in width and length than a gift card. One tab is defined by the lines from points 88 to 80 to 82 to 84 to 90 to 88, while the other tab takes its shape from the lines 89 to 81 to 93 to 85 to 91 to 89. The two tabs are spaced apart and generally symmetrical about the cut line 82 to 83. Outwardly from the tabs and towards the fold lines 78 to 79 and 86 to 87, each location has four corner regions with two at each end of a fold line. A corner region separates from the mailer using perforations so that a sender can load a gift card into the mailer. Each corner region has a symmetric shape about a forty five degree axis through corners at points 90, 93, 94, and 95. The corners are generally L shape with equal length legs and each leg ends in a forty five degree perforation such as at 78 and 88, 79 and 89, 86 and 90, 87 and 91. Though this one location is described, the description applies to the four locations shown in FIG. 18. Further, additional or fewer locations may be used depending upon the desires of the sender of the mailer.

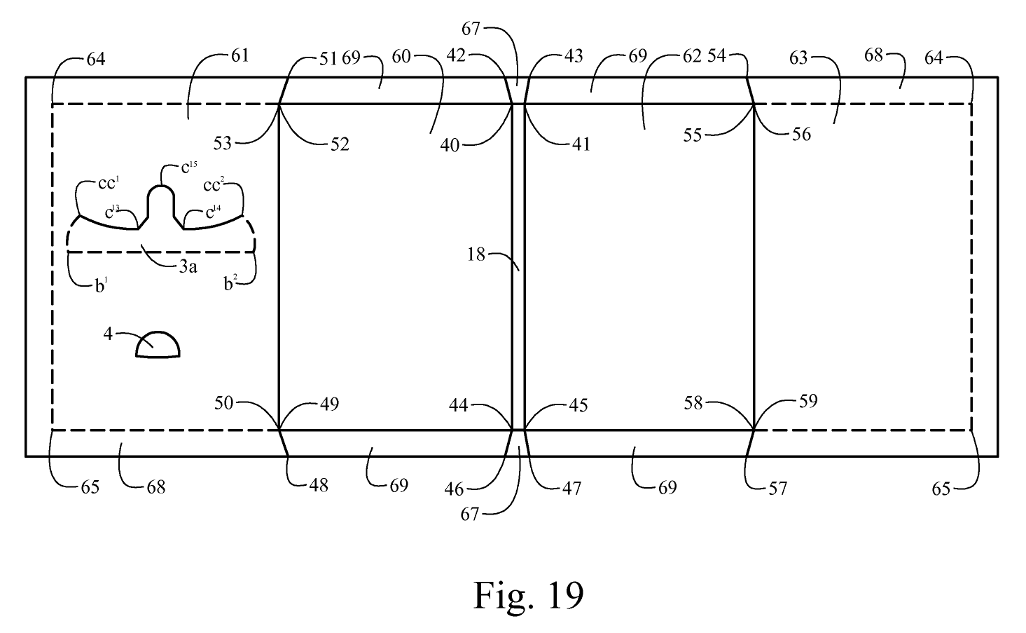

Building upon the holder embodiment in FIG. 10, FIG. 19 shows a stylized scoop 3a in the inside back cover 61 of the mailer. This location has a tab 4 as previously described for the bottom edge of a CD. The tab extends below the plane of the mailer behind the CD. Away from the tab 4, the stylized scoop begins with a perforation line between points b1 and b2 that extends parallel to the longitudinal axis of the mailer. Perforations then extend from points b1 to cc1, and b2 to cc2. Points cc1 and cc2 are away and slightly inside of points b1, b2. Then the scoop 3a has a cut line from cc1 to c13 to c15 to c14 to cc2. This cut line represents the outline of a structure or other artistic work suitable for extending near the diameter of a CD at the location. Here points c13 and c14 represent the base of a structure, such as a capitol building, and point c15 is the top or tip of a capitol dome. Though a capitol building is shown, other structures can be used.

Though various locations, scoops, and holders have been described for FIGS. 13-19, the locations, scoops, and holders can be interchanged to suit the needs of the sender of the mailer. The sender may use creativity in positioning the locations. Generally, the locations for holding CD and gift cards are positioned in the inside back cover 61 and the inside front cover 63 so that upon folding them upon fold lines 49 to 52 and 55 to 58, the CD and gift cards remain upon the interior of the mailer. In usage, the strip chads 68 and chads 67 are removed and the CD or gift cards inserted in to the locations. The tabs 69 are then folded inwardly towards the interior of the front cover 62 and the back cover 60, or towards the direction that the inside back cover and the inside front cover fold. Then the inside back cover and the inside front cover are folded upon fold lines 49 to 52 and 55 to 58 respectively towards the spine 18. The inside back cover and the inside front cover then are secured to the tabs using adhesives of various kinds and then the back cover and the front cover are folded upon the fold lines 40 to 44 and 41 to 45, or along the spine 18, so that the front cover is parallel to the back cover with the inside back cover and the inside front cover upon the interior of the mailer. The mailer that began as 8½ inch by 22 inches sheet then becomes slightly more than a 5 inch by 7 inch size card suitable for shipment through the mails including a CD, business card, gift card, or other media therein secured by scoops, slits, tabs, straps, and the like cut or perforated into the mailer as described.

From the aforementioned description, a rear loading media storage device has been described. The rear loading media storage device is uniquely capable of retaining media upon a planar material, loading media into the device from the rear, and notifying merchants and buyers when media has been removed from the device. The device can then be folded for display upon a retail shelf or for shipment through the mails. The rear loading media storage device and its various components may be manufactured from many materials, including but not limited to, polymers, high density polyethylene, polypropylene, paperboard, waxed cardstock, cardboard, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device for storing media and marketing materials, said device warning a user when said media is removed, the media having a thickness, a width and a perimeter, comprising:
at least one panel having a front and an opposite rear; and,
at least one arrangement upon the front of said at least one panel securing at least one of the media or the marketing materials upon the rear of said at least one panel.

2. The media storage device of claim 1 further comprising:
said arrangement having at least one member spaced outwardly of the media in excess of the perimeter of the media or the marketing materials.

3. The media storage device of claim 2 further comprising:
said at least one member being spaced outwardly at least 10% more than the perimeter of the media or the marketing materials.

4. The media storage device of claim 2 further comprising:
said members spaced outwardly from the perimeter of the media at least 1.5 times the thickness of the media.

5. The media storage device of claim 2 further comprising:
said at least one arrangement including a tab generally opposite said at least one member, said tab generally extending away from the rear of said panel and locating behind the media when inserted into said device.

6. The media storage device of claim 1 further comprising:
at least one warning upon said panel within said arrangement, concealed behind the media when inserted into said device, and visible upon the front of said panel when the media is removed.

7. The media storage device of claim 2 further comprising
each of said members including an instruction printed thereon generally for removing said member following purchase by a user.

8. The media storage device of claim 2 further comprising
two of said members being chords, each chord extending outwardly from a point spaced away from the center of said arrangement and reaching beyond the perimeter of the media.

9. The media storage device of claim 2 further comprising
two of said members being bands, each band extending outwardly from a centerline through the center of said arrangement and reaching beyond the perimeter of the media.

10. The media storage device of claim 2 further comprising
two of said members being flaps, each flap extending inwardly from outside the perimeter of said device towards the center of said arrangement.

11. The media storage device of claim 1 further comprising
said arrangement including one band, extending outwardly from the center of said arrangement and reaching beyond the perimeter of the media.

12. The media storage device of claim 1 further comprising
said arrangement including at least one scoop, extending upwardly from the centerline of said arrangement and reaching beyond the perimeter of the media, said scoop narrowing in width proximate the center of said arrangement and expanding in width outwardly from the center.

13. The media storage device of claim 1 further comprising:
said arrangement including at least two stylized bands and a curved baseline through the center of said arrangement, each of said bands extending from the baseline reaching beyond the perimeter of the media.

14. The media storage device of claim 2 wherein one band has a non-rectangular shape and at least two other bands extend from the baseline towards a juncture proximate the perimeter of said device.

15. The media storage device of claim 1 further comprising:
one of said panels having a longitudinal opening thus forming a pocket.

16. The media storage device of claim 11 wherein said band is a business card oriented either landscape or portrait.

17. The media storage device of claim 1 further comprising:
four panels including an inside back cover, a back cover, a front cover and an inside front cover;
a spine commonly contiguous between said back cover and said front cover upon mutually parallel living hinges;
said inside back cover contiguous with said back cover upon a living hinge, said back cover contiguous with said spine upon a living hinge, said spine contiguous with said front cover upon a living hinge generally parallel to the living hinge with said back cover, and said front cover contiguous with said inside front cover upon a living hinge; and,
at least one of said inside back cover, said inside front cover, or both having said at least one arrangement storing the media wherein upon folding said inside back cover upon said back cover or said inside front cover upon said front cover the media remains secured within the interior of said device.

18. The media storage device of claim 17 further comprising:
at least one of said back cover or said front cover having said at least one arrangement storing the marketing materials wherein upon folding said back cover upon said front cover the marketing materials remain secured upon the exterior of said device.
